(19) United States
(12) Patent Application Publication
(10) Pub. No.: US 2026/0195140 A1
(43) Pub. Date: Jul. 9, 2026

(54) INFORMATION HANDLING SYSTEM WITH AUTOMATIC DETECTION AND CONFIGURATION OF LANGUAGE MODEL AND LAYOUT OF A KEYBOARD

(71) Applicant: DELL PRODUCTS L.P., Round Rock, TX (US)

(72) Inventors: Allen B. McKittrick, Cedar Park, TX (US); Daniel Hamlin, Round Rock, TX (US); Adolfo Montero, Pflugerville, TX (US)

(21) Appl. No.: 19/015,335

(22) Filed: Jan. 9, 2025

(51) Int. Cl. G06F 9/445; G06F 1/16; G06F 3/02; G06F 9/451

(52) U.S. Cl. CPC G06F 9/44505; G06F 1/1662; G06F 9/454; G06F 3/0227

(57) ABSTRACT

An information handling system includes an embedded controller that detects the presence of a keyboard within the information handling system. The embedded controller also determines a language identification associated with the keyboard. Based on the language identification being different than a current language identification, a processor receives the language identification from the embedded controller. Based on the language identification, the processor configures a localized language for an operating system of the information handling system.

### FIELD OF THE DISCLOSURE

The present disclosure generally relates to information handling systems, and more particularly relates to automatically detecting and configuring a language model and layout of a keyboard of an information handling system.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system includes an embedded controller and a processor. The embedded controller may detect the presence of a keyboard of the information handling system. The embedded controller also may determine a language identification associated with the keyboard. Based on the language identification being different than a current language identification, the processor may receive the language identification from the embedded controller. Based on the language identification, the processor may configure a localized language for an operating system of the information handling system.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a perspective view of an information handling system according to at least one embodiment of the present disclosure;

FIG. 2 is a block diagram of a portion of an information handling system according to at least one embodiment of the present disclosure;

FIG. 3 is a flow diagram of a method for automatically detecting and configuring a language model and layout of a keyboard of an information handling system according to at least one embodiment of the present disclosure; and

FIG. 4 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

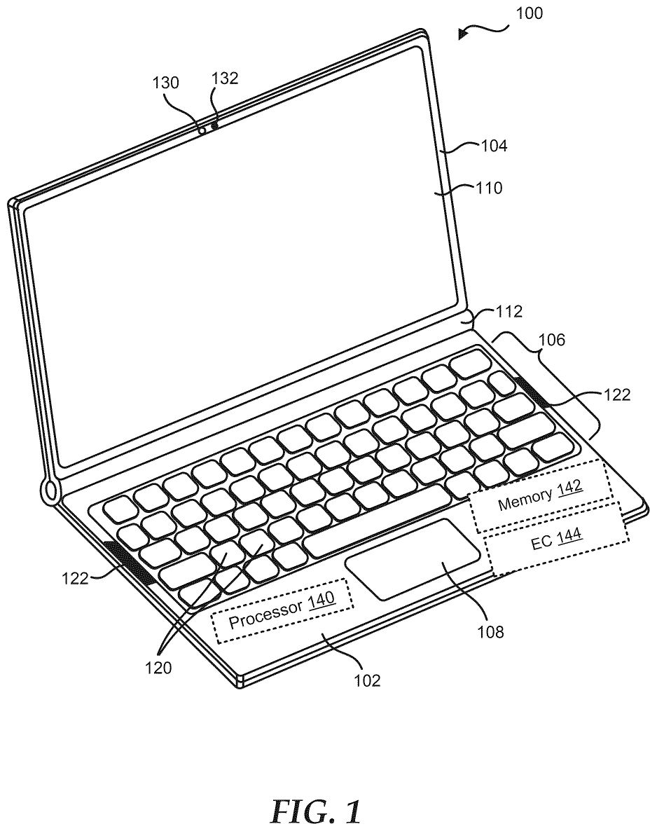

FIG. 1 illustrates an information handling system 100 according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 100 includes a base portion 102 and a top 104. Base portion 102 includes a keyboard 106 and a touchpad 108, and top portion 104 includes a display device 110. In an example, touchpad 108 may be any suitable pointing device. Base portion 102 is connected top portion 104 via a mechanism 112, such as one or more hinges. Keyboard 106 includes multiple keys 120. Base portion 102 further includes speakers 122. Top portion 104 includes a camera 130 and a microphone 132. Information handling system 100 further includes a processor 140, a memory 142, and an embedded controller 144. In certain examples, memory 142 may be located within embedded controller 144 or may be external to the embedded controller. Information handling system 100 may include additional components without varying from the scope of the disclosure.

When the information handling system 100 includes a 2-in-1 device, mechanism 112 may enable the top portion 104 to be connected to bottom portion 102 for use as a laptop device and may enable the top portion 104 to be detached from bottom portion 102 to enable the top portion 104 to be used as a tablet information handling system. Display device 110 may include one or more light emitting devices, such as, for example, light emitting diodes (LEDs), organic LED (OLED), liquid crystal display (LCD), another type of light emitting device, or any combination thereof.

In certain examples, different keyboards 106 may be connected to information handling system 100, and the different keyboards 106 may have different layouts of keys 120. The different layouts of keys 120 may be based on the language associated with keyboard 106. For example, one layout of keys 120 in keyboard 120 may be a QWERTY layout for the languages of the United States, Canada, Australia, New Zealand, Brazil, Italy, Ireland, and numerous other countries. Other arrangements include a QWERTZ layout used for the languages of Germany, Austria, Switzerland, and other Central and Eastern European countries, an AZERTY layout for the languages of France, Belgium, and Luxembourg, or other layouts for other languages.

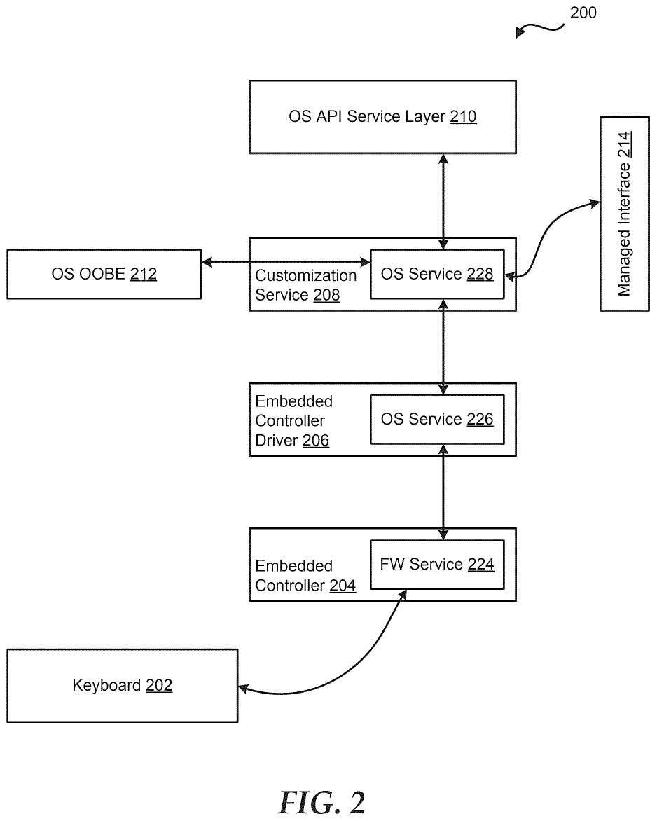

In an example each different keyboard 106 may be identified by embedded controller 144 via any suitable manner, such as a location or type of a magnet within the keyboard, general purpose input/output (GPIO) mapping, inter-integrated circuit (I2C) custom status capabilities, or the like. In response to the detected layout of keys 120 in keyboard 106, embedded controller 144 may determine a language associated with the keyboard. In certain examples, the determination of the language may be based on data stored in memory 142. Upon identification of the language associated with keyboard 106, embedded controller 144 may provide this information to an operating system (OS) agent executed by processor 140. Processor 140 may execute the OS agent to communicate with the OS localization service to configure the keyboard language and OS settings within information handling system 100. Operations of processor 140 and embedded controller 144 to configure the keyboard language and OS settings will be described with respect to FIG. 2.

FIG. 2 illustrates a portion of an information handling system 200 according to at least one embodiment of the present disclosure. Information handling system 200 may be substantially similar to information handling system 100 of FIG. 1. Information handling system 200 includes a keyboard 202, an embedded controller 204, and an embedded controller driver 206. Information handling system 200 also includes different services executed by a processor, such as processor 140 of FIG. 1. These services include a customization service 208, an OS application programming interface (API) service layer 210, an OS out-of-box experience (OOBE) 212, and a managed interface 214. A firmware (FW) service 224 may be executed by embedded controller 204, an OS service 226 may be implemented within EC driver 206, and an OS service 228 may be implemented with customization service 208. In certain examples, SW services 226 and 228 may be incorporated in the same SW service without varying from the scope of this disclosure. Information handling system 200 may include additional components and services without varying from the scope of this disclosure.

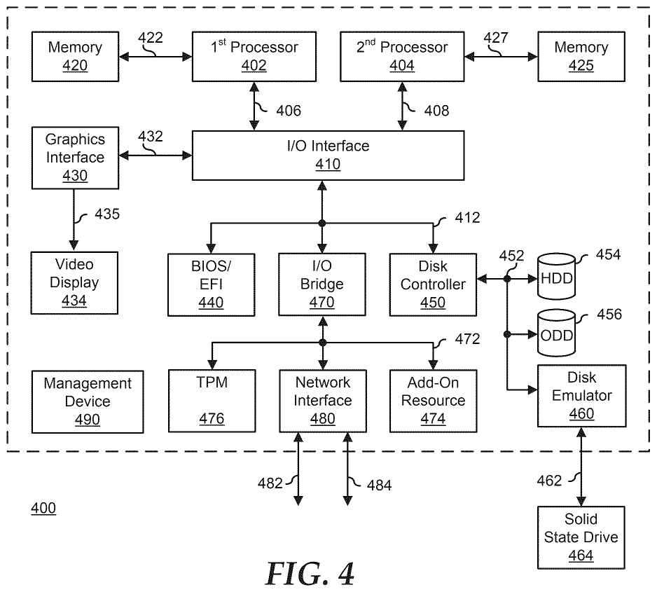

During a boot operation of information handling system 200, embedded controller 204 may execute FW service 224 to detect keyboard 202. In certain examples, embedded controller 204 may detect keyboard 202 by utilizing any suitable mechanisms for unique determination including, but not limited to, GPIO mapping, I2C custom status capabilities, magnet mapping, or the like. In response to detecting keyboard 202, embedded controller 204 may utilize FW service 224 to determine a language identification (ID) associated with the keyboard based on one or more of the mechanisms listed above. In an example, FW service 224 may store the language ID for keyboard 202 in a memory of embedded controller 204, such as memory 142 of FIG. 1 or memories 420 and 425 of FIG. 4.

During a first installation of information handling system 200, a processor may run or execute OS OOBE 212. In an example, OS OOBE 212 may be utilized to set up initial configurations of information handling system 200, such as an initial language configuration for both keyboard 202 and an OS of information handling system 200. If information handling system 200 is running OS OOBE 212, FW service 224 may provide the language ID associated with keyboard 202 to SW service 228 via SW service 226. In response to receiving the language ID, SW service 228 may directly modify, or reconfigure the OOBE.xml setting within OS OOBE 212. In an example, OS OOBE 212 may communicate with an individual/user of information handling system 200 in any particular manner to enable the individual to verify the language ID of keyboard 202 and OS of information handling system 200.

In certain examples, SW service 226 within EC driver 206 may perform operations as a communication service of information handling system 200. For example, SW service 226 may communicate data between FW service 224 and SW service 228. SW service 226 may be a distributed service in system context and may provide direct hardware access to FW service 224 of embedded controller 204. In an example, the communication or access of FW service 224 by SW service 226 may be through any known communication protocol including, but not limited to, memory mapped input/output (MMIO), Windows management instrumentation (WMI), and serial communication interface (SCI). In certain examples, SW service 228 may run in a host OS executed by a processor, such as processor 140 of FIG. 1. SW service 228 may be responsible for communicating with FW service 224 and providing localization information to other OS level SW services within information handling system 200.

If the boot operation is not a first installation of information handling system 200, FW service 224 may determine whether the determined language ID of keyboard 202 stored in the memory is the same language ID that is currently set up or configured within the information handling system. If the language ID is the same as currently set, FW service 224 of embedded controller 204 may determine that no alert or interrupt should be provided to SW service 226. Additionally, if the language ID is the same as previously set, FW service 224 of embedded controller 204 may ignore any OS calls for the language ID from SW service 226.

In certain examples, SW service 226 may provide an OS call, such as a get local language ID call, to FW service 224. In response to the OS call and the language ID being different than the previous, FW service 224 may provide the language ID for keyboard 202 from the memory of embedded controller 204 to OS service 226. In certain examples, FW service 224 may provide the language ID for keyboard 202 via an interrupt-based notification without first receiving the language ID call from SW service 226. In an example, the interrupt-based notification may provide the language ID and associated localization configuration needs for information handling system 200 based on keyboard 202.

In an example, SW service 228 may run in a host OS and may be responsible for collecting system configuration state information from OS service 226. Based on the collection system configuration state information and the language ID of keyboard 202, SW service 228 may orchestrate an OS configuration for the desired localized language. In an example, SW service 228 may run as part of customization service 208 within a user mode driver of information handling system 200. For example, SW service 228 may run as a distributed service that may receive data from OS service 226 via known driver communication paths.

In response to SW service 228 receiving the language ID for keyboard 202 from SW service 226, SW service 228 may perform one or more operations to configure the OS language and keyboard customization within information handling system 200. For example, SW service 228 may detect or determine the existing OS language and keyboard configuration setting of runtime OS of information handling system 200. In an example, the determination of the existing OS language and keyboard configuration may be performed during any suitable boot stage, such as being performed during the service initialization of information handling system 200. SW service 228 may determine whether a new language configuration is needed within the OS of information handling system 200. If a new language configuration is needed, SW service 228 may determine whether a language pack for the language ID of keyboard 202 is located in the OS. If the language pack for the language ID is not present within the OS, SW service 228 may notify the OS to download language pack. The language pack may be utilized to configure different applications of the OS provide the language to an individual associated with information handling system 200.

In an example, SW service 228 may communicate with a managed entity via managed interface 214 to request a push of the targeted language pack. In this situation, the managed entity may modify the language setting in OS documents. The managed entity may also send the modified language setting to an information technology (IT) support provider for information handling system 200. In certain examples, SW service 228 make utilize application programming interface (API) call to the API service layer 210 to configure the OS to modify system language settings and align with the language of keyboard 202.

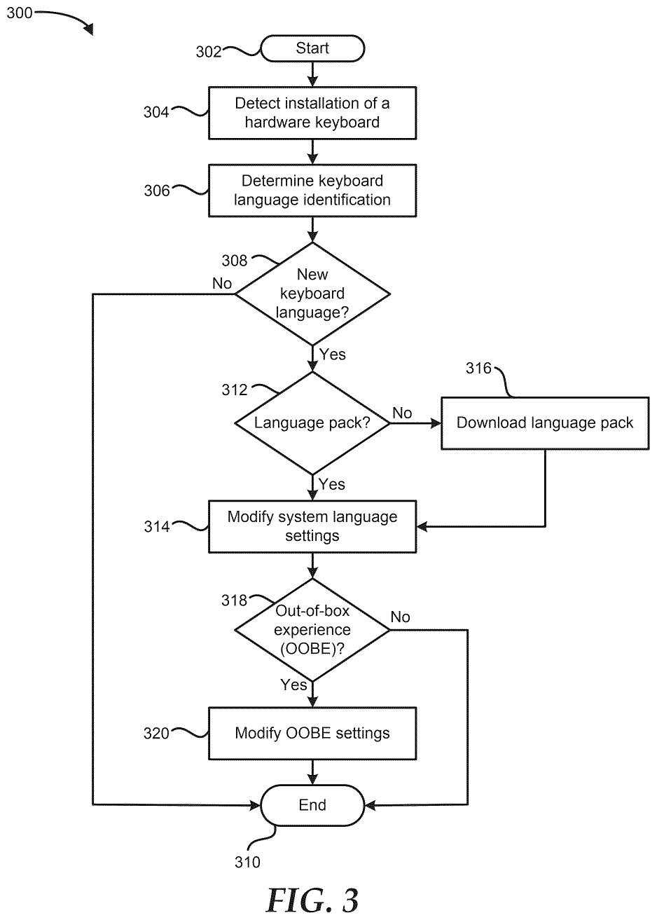

FIG. 3 is a flow diagram of a method 300 for automatically detecting and configuring a language model and layout of a keyboard within an information handling system according to at least one embodiment of the present disclosure, starting at block 302. It will be readily appreciated that not every method step set forth in this flow diagram is always necessary, and that certain steps of the methods may be combined, performed simultaneously, in a different order, or perhaps omitted, without varying from the scope of the disclosure. FIG. 3 may be employed in whole, or in part, processor 140 and embedded controller 144 of FIG. 1, or any other type of controller, device, module, processor, or any combination thereof, operable to employ all, or portions of, the method of FIG. 3.

At block 304, an installation of a hardware keyboard is detected. In an example, the keyboard may be detected by any suitable component of an information handling system. For example, the keyboard detection may be made by an embedded controller executing a FW service. In certain examples, the embedded controller may detect a hardware keyboard by utilizing suitable mechanisms for unique determination including but not limited to GPIO mapping, I2C custom status capabilities, magnet mapping, or the like.

At block 306, a language ID for the keyboard is determined. In an example, the language ID for the keyboard may be determined in any suitable manner. For example, the embedded controller may also utilize one of the mechanisms stated above to determine the language ID for the keyboard. In certain examples, the embedded controller may include a memory that stores a table, which in turn correlates a particular keyboard feature/identifier to a particular language ID.

At block 308, a determination is made whether the determined language ID is different from a current language ID. If a different language ID is not determined, the flow ends at block 310. If a different language is determined, a determination is made whether a language pack for the language ID is located within the OS of the information handling system at block 312. In an example, a language pack may enable the OS to adapt its display to features in a particular language. If a language pack is located within the OS, the flow continues at block 314. If a language pack is not located within the OS, the language pack is downloaded at block 316 and the flow continues at block 314.

At block 314, system language settings are modified. In an example, a SW service of the OS may modify the system language settings based on the corresponding language pack. At block 318, a determination is made whether the information handling system is performing or executing an OOBE. In an example, the OOBE may be executed on the first initialization of the information handling system and may be used to set particular configurations for the information handling system, such as the language for the information handling system.

If the OOBE is not being executed, the flow ends at block 310. If the OOBE is being executed, OOBE settings are modified at block 320 and the flow ends at block 310. In an example, the OOBE settings may be modified in any suitable manner, such as a SW service directly modifying or reconfiguring an OOBE.xml setting within an OS OOBE.

FIG. 4 shows a generalized embodiment of an information handling system 400 according to an embodiment of the present disclosure. Information handling system 400 may be substantially similar to information handling system 100 of FIG. 1. Further, information handling system 400 can include processing resources for executing machine-executable code, such as a central processing unit (CPU), a programmable logic array (PLA), an embedded device such as a System-on-a-Chip (SoC), or other control logic hardware. Information handling system 400 can also include one or more computer-readable medium for storing machine-executable code, such as software or data. Additional components of information handling system 400 can include one or more storage devices that can store machine-executable code, one or more communications ports for communicating with external devices, and various input and output (I/O) devices, such as a keyboard, a mouse, and a video display. Information handling system 400 can also include one or more buses operable to transmit information between the various hardware components.

Information handling system 400 can include devices or modules that embody one or more of the devices or modules described below and operates to perform one or more of the methods described below. Information handling system 400 includes a processors 402 and 404, an input/output (I/O) interface 410, memories 420 and 425, a graphics interface 430, a basic input and output system/universal extensible firmware interface (BIOS/UEFI) module 440, a disk controller 450, a hard disk drive (HDD) 454, an optical disk drive (ODD) 456, a disk emulator 460 connected to an external solid state drive (SSD) 464, an I/O bridge 470, one or more add-on resources 474, a trusted platform module (TPM) 476, a network interface 480, a management device 490, and a power supply 495. Processors 402 and 404, I/O interface 410, memory 420, graphics interface 430, BIOS/UEFI module 440, disk controller 450, HDD 454, ODD 456, disk emulator 460, SSD 464, I/O bridge 470, add-on resources 474, TPM 476, and network interface 480 operate together to provide a host environment of information handling system 400 that operates to provide the data processing functionality of the information handling system. The host environment operates to execute machine-executable code, including platform BIOS/UEFI code, device firmware, operating system code, applications, programs, and the like, to perform the data processing tasks associated with information handling system 400.

In the host environment, processor 402 is connected to I/O interface 410 via processor interface 406, and processor 404 is connected to the I/O interface via processor interface 408. Memory 420 is connected to processor 402 via a memory interface 422. Memory 425 is connected to processor 404 via a memory interface 427. Graphics interface 430 is connected to I/O interface 410 via a graphics interface 432 and provides a video display output 436 to a video display 434. In a particular embodiment, information handling system 400 includes separate memories that are dedicated to each of processors 402 and 404 via separate memory interfaces. An example of memories 420 and 430 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 440, disk controller 450, and I/O bridge 470 are connected to I/O interface 410 via an I/O channel 412. An example of I/O channel 412 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 410 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 440 includes BIOS/UEFI code operable to detect resources within information handling system 400, to provide drivers for the resources, initialize the resources, and access the resources. BIOS/UEFI module 440 includes code that operates to detect resources within information handling system 400, to provide drivers for the resources, to initialize the resources, and to access the resources.

Disk controller 450 includes a disk interface 452 that connects the disk controller to HDD 454, to ODD 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits SSD 464 to be connected to information handling system 400 via an external interface 462. An example of external interface 462 includes a USB interface, an IEEE 4394 (Firewire) interface, a proprietary interface, or a combination thereof. Alternatively, solid-state drive 464 can be disposed within information handling system 400.

I/O bridge 470 includes a peripheral interface 472 that connects the I/O bridge to add-on resource 474, to TPM 476, and to network interface 480. Peripheral interface 472 can be the same type of interface as I/O channel 412 or can be a different type of interface. As such, I/O bridge 470 extends the capacity of I/O channel 412 when peripheral interface 472 and the I/O channel are of the same type, and the I/O bridge translates information from a format suitable to the I/O channel to a format suitable to the peripheral channel 472 when they are of a different type. Add-on resource 474 can include a data storage system, an additional graphics interface, a network interface card (NIC), a sound/video processing card, another add-on resource, or a combination thereof. Add-on resource 474 can be on a main circuit board, on separate circuit board or add-in card disposed within information handling system 400, a device that is external to the information handling system, or a combination thereof.

Network interface 480 represents a NIC disposed within information handling system 400, on a main circuit board of the information handling system, integrated onto another component such as I/O interface 410, in another suitable location, or a combination thereof. Network interface device 480 includes network channels 482 and 484 that provide interfaces to devices that are external to information handling system 400. In a particular embodiment, network channels 482 and 484 are of a different type than peripheral channel 472 and network interface 480 translates information from a format suitable to the peripheral channel to a format suitable to external devices. An example of network channels 482 and 484 includes InfiniBand channels, Fibre Channel channels, Gigabit Ethernet channels, proprietary channel architectures, or a combination thereof. Network channels 482 and 484 can be connected to external network resources (not illustrated). The network resource can include another information handling system, a data storage system, another network, a grid management system, another suitable resource, or a combination thereof.

Management device 490 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 400. In particular, management device 490 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 400, such as system cooling fans and power supplies. Management device 490 can include a network connection to an external management system, and the management device can communicate with the management system to report status information for information handling system 400, to receive BIOS/UEFI or system firmware updates, or to perform other task for managing and controlling the operation of information handling system 400.

Management device 490 can operate off of a separate power plane from the components of the host environment so that the management device receives power to manage information handling system 400 when the information handling system is otherwise shut down. An example of management device 490 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 490 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
an embedded controller to:
detect a presence of a keyboard of the information handling system; and
determine a language identification associated with the keyboard; and
a processor to communicate with the embedded controller, the processor to:
based on the language identification being different than a current language identification, receive the language identification from the embedded controller; and
based on the language identification, configure a localized language for an operating system of the information handling system.

2. The information handling system of claim 1, further comprising:
a memory to store the language identification for the keyboard,
wherein the embedded controller further to:
compare the language identification with the current language identification; and
in response to the language identification being different than the current language identification, store the language identification in the memory.

3. The information handling system of claim 1, wherein the processor to provide an operating system call to the embedded controller, wherein the operating system call includes a request for the language identification associated with the keyboard.

4. The information handling system of claim 3, wherein in response to both the operating system call and the language identification being different than the current language identification, the embedded controller to provide the language identification to the processor.

5. The information handling system of claim 3, wherein in response to the language identification being a same as the current language identification, the embedded controller to ignore the operating system call.

6. The information handling system of claim 1, wherein in response to the language identification being different than the current language identification, the embedded controller to provide an interrupt-based alert to the processor, wherein the interrupt-based alert includes the language identification.

7. The information handling system of claim 1, when an operating system out-of-box experience (OOBE) is running in the information handling system, the processor further to: modify an OOBE setting within the operating system, wherein the OOBE setting is a language selection of the operating system.

8. The information handling system of claim 7, wherein the OOBE setting is an OOBE.xml setting.

9. The information handling system of claim 1, wherein the processor further to:
determine whether the operating system includes a language pack associated with the language identification of the keyboard; and
in response to the operating system not including the language pack, download the language pack.

10. A method comprising:
detecting, by an embedded controller in an information handling system, a presence of a keyboard of the information handling system;
determining a language identification associated with the keyboard based on the language identification being different than a current language identification, receiving, by a processor of the information handling system, the language identification from the embedded controller; and
based on the language identification, configuring, by the processor, a localized language for an operating system of the information handling system.

11. The method of claim 10, further comprising:
comparing the language identification with the current language identification; and
in response to the language identification being different than the current language identification, storing the language identification in a memory.

12. The method of claim 10, further comprising: providing an operating system call to the embedded controller, wherein the operating system call includes a request for the language identification associated with the keyboard.

13. The method of claim 12, wherein in response to both the operating system call and the language identification being different than the current language identification, providing, by the embedded controller, the language identification to the processor.

14. The method of claim 12, wherein in response to the language identification being a same as the current language identification, ignoring, by the embedded controller, the operating system call.

15. The method of claim 10, wherein in response to the language identification being different than the current language identification, providing, by the embedded controller, an interrupt-based alert to the processor, wherein the interrupt-based alert includes the language identification.

16. The method of claim 10, when an operating system out-of-box experience (OOBE) is running in the information handling system, the method further comprises: modifying an OOBE setting within the operating system, wherein the OOBE setting is a language selection of the operating system.

17. The method of claim 16, wherein the OOBE setting is an OOBE.xml setting.

18. The method of claim 10, wherein the processor further to:
determining whether the operating system includes a language pack associated with the language identification of the keyboard; and
in response to the operating system not including the language pack, downloading the language pack.

19. An information handling system comprising:
a memory to store a language identification for a keyboard;
an embedded controller to:
detect a presence of the keyboard within the information handling system; and
determine the language identification associated with the keyboard; and
a processor to:
provide an operating system call to the embedded controller, wherein the operating system call includes a request for the language identification associated with the keyboard;
if the language identification is different than a current language identification, then receive the language identification from the embedded controller; and
based on the language identification, configure a localized language for an operating system of the information handling system.

20. The information handling system of claim 19, when an operating system out-of-box experience (OOBE) is running in the information handling system, the processor further to: modify an OOBE setting within the operating system, wherein the OOBE setting is a language selection of the operating system.
